(19) United States
(12) Patent Application Publication
(10) Pub. No.: US 2014/0067325 A1
(43) Pub. Date: Mar. 6, 2014

(54) Analytics in a Utility Infrastructure

(71) Applicants: Darby McKee, Liberty Lake, WA (US); Bruce Angelis, Liberty Lake, WA (US); Fred Behrmann, Liberty Lake, WA (US); James Poxleitner, Cottonwood, ID (US); Robert Sonderegger, Liberty Lake, WA (US)

(72) Inventors: Darby McKee, Liberty Lake, WA (US); Bruce Angelis, Liberty Lake, WA (US); Fred Behrmann, Liberty Lake, WA (US); James Poxleitner, Cottonwood, ID (US); Robert Sonderegger, Liberty Lake, WA (US)

(73) Assignee: ITRON, INC., Liberty Lake, WA (US)

(21) Appl. No.: 13/824,180

(22) PCT Filed: Jan. 23, 2013
(86) PCT No.: PCT/US2013/022814

§ 371 Date: Mar. 15, 2013

Related U.S. Application Data
(60) Provisional application No. 61/589,816, filed on Jan. 23, 2012.

(51) Int. Cl. G01D 4/00

(52) U.S. Cl. CPC G01D 4/002
USPC 702/183

(57) ABSTRACT

Techniques for analyzing a utility infrastructure are described herein. In one example, data is obtained from a utility system. The data may include consumption measurement information, consumption measurement exceptions and/or system events. Exceptions may include data indicating a possible problem, such as significantly increased or decreased consumption, reduced voltage, etc. Events may include data on power down actions, meter removal, etc. Attributes may be considered, including demographic information, weather information, economic information, etc. The data may be filtered by comparison to known patterns of measurements, exceptions, events and/or attributers that indicate an analytic event. Accordingly, analytic events may include important system information that is inferred from large quantities of data. Analytic events may be reported to an operator through operation of a user interface.

### RELATED APPLICATIONS

This patent application claims priority to PCT Patent Application Serial No. PCT/US13/22814 filed on 23 Jan. 2013 titled “Analytics in a Utility Infrastructure”, which claims priority to U.S. Patent Application Ser. No. 61/589,816, titled “Active Smart Grid Analytics”, filed on 23 Jan. 2012, commonly assigned herewith, which is incorporated herein by reference.

### BACKGROUND

Utility companies provide electricity, gas, water, heat, steam, and other consumables or services (e.g., sewer, etc.) to consumers. A utility company may offer such services over a considerable geographic area and to a large number of consumers. Utility companies have increasingly networked their infrastructure, and considerable data is generated from measurement points throughout their systems. In theory, the data is usable by operators, who can use the data to recognize problems and to correct them. In practice, the flood of data that results from successful operation of the network tends to bury important data points that indicate problems that should be addressed. Thus, while data may indicate problems with a utility system that should be addressed, in many cases that data is simply not recognized or comprehended by operators of those systems.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a block diagram showing an example network from which data may be obtained, including a central office configured for performing techniques in analytics in a utility infrastructure environment.

FIG. 2 is a block diagram showing example structure of a system configured for performing analytics in a utility infrastructure environment.

FIG. 3 is an example of a user interface configured as part of an analytics system configured for operation in a utility infrastructure environment.

FIG. 4 is a flow diagram showing example operation of analytic techniques in a utility infrastructure environment.

FIG. 5 is a circuit diagram illustrating example operation of the analytic techniques in a utility environment, including example identification of sequential and/or nested analytic events.

### DETAILED DESCRIPTION

### Overview

Techniques for implementing and operating analytics in a utility infrastructure environment are described herein. In one example of the techniques, data is obtained from a utility system. The data may be related to electricity, gas, water, steam, sewer, etc. The data may include measurement information indicating consumption and other measures at endpoints, meters, transformers, switches, substations and/or other devices and points throughout the system. The data may also include exceptions, events and/or other system or operational data. Exceptions may include anomalous measurements or other data. Such anomalies may indicate a possible problem. For example, significantly increased consumption may indicate a broken water pipe, while decreased consumption may indicate electrical theft. Events may include activities (e.g., a power-down of service to a customer) that do not depend on the context of the activity. Thus, such an event may be recognized without taking into account other events, measurements, etc. Additionally, the data may be analyzed using one or more relevant attributes, such as characteristics of the consumer, network and/or environment. Examples of attributes include information that was not obtained from metering devices, such as demographic information (e.g., the consumer is a restaurant, or the consumer's house is over-sized), environmental information (e.g., it's a cold winter day) or economic information. Additionally, attributes and/or a connectivity model or network topology may be used to derive an analytic event. Such a connectivity attribute and/or connectivity model could show devices that are connected and/or related to a particular device or node on the network or grid. Such attributes may be used and helpful in deriving analytic events.

Analytic events are useful combinations and/or sequences found in data. They may be identified in real time or near real time. They are valuable in that they may be used to monitor and improve the operational health of a utility system, to discover utility theft or diversion, indicate potential safety issues, or for other purposes. An analytic event may be formed of “building blocks” including measurement data, exceptions, events, attributes, previously identified analytic events, and/or groups or patterns of previously identified analytic events.

An event derivation, event inference and/or pattern-based data filtration and/or examination process may be used to identify analytic events. The data may be filtered or examined to identify patterns of data elements. The patterns may include at least one measurement, exception and/or event. The patterns may be selected and/or based on one or more attributes that are relevant to a consumer. The data may be compared to a number of patterns to search for a number of respective analytic events. Thus, an analytic event may be recognized based at least in part on measurements, exceptions, events, attributes and previously identified analytic events. In a specific example, a meter removal event, followed by measurements including a period of lower than normal consumption (which may be considered to be an exception), followed by another meter removal event, may indicate an analytic event (e.g., a meter bypass). Such analytic events, which may be derived by recognition of a plurality of indicative data elements, may indicate electricity theft. In another example, a conservation analytic event may include events that related to utility losses, such as electrical theft, water or gas leaks, and/or other events that indicate loss to a utility system. Analytic events may be reported to an operator through operation of a user interface. In one example, the analytic events may be prioritized and reported to an operator. In other examples, analytic events may be used to initiate action through operation of automated systems.

The discussion herein includes several sections. Each section is intended to be an example of techniques and/or structures, but is not intended to indicate elements which must be used and/or performed. A section entitled “Example System and Techniques” discusses example structures and implementations that scan and filter measurement data, exception data and event data. Additionally, the example structures perform pattern-matching functionality to locate and/or infer analytic events. A section entitled “Example User Interface” discusses example output of analytics from a utility infrastructure. A section entitled “Example Methods” discusses aspects of methods operational in devices including processors, memory devices, application specific integrated circuits (ASICs), etc. In particular, the example methods may be applied to any of the techniques discussed herein, including those of the following sections.

### Example System and Techniques

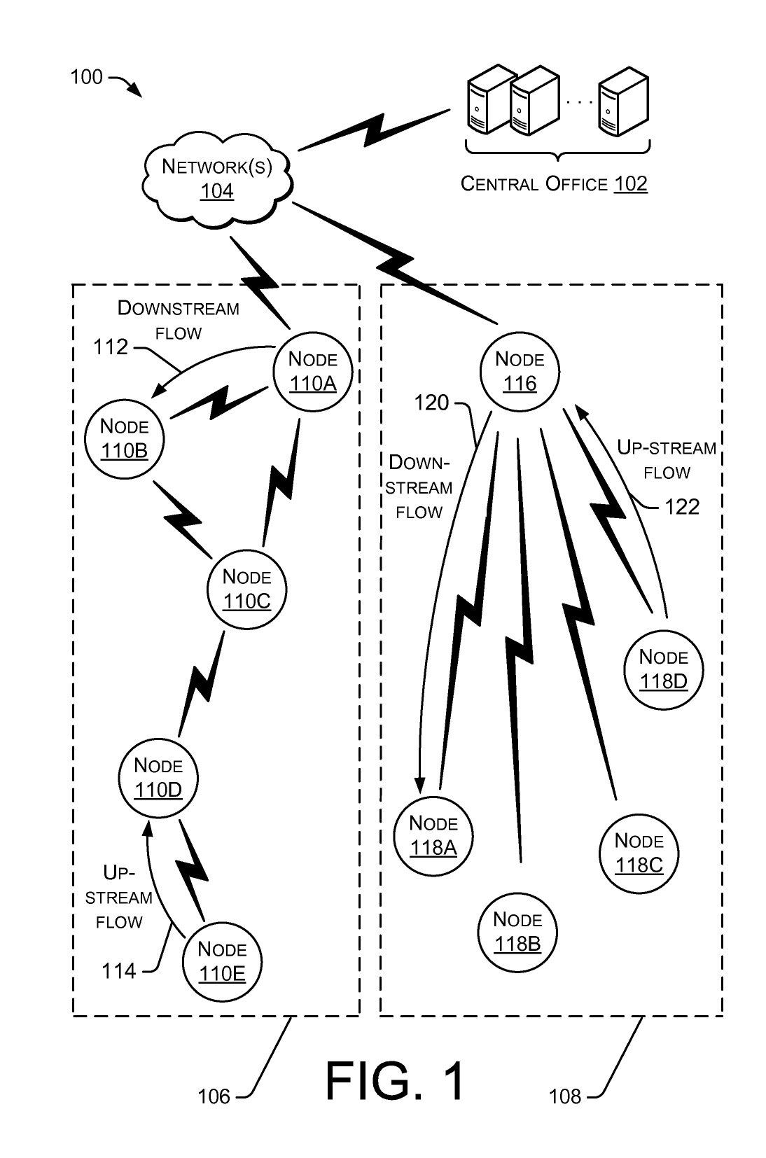

FIG. 1 is a block diagram showing an example network 100 from which data may be obtained. The network 100 may include a central office 102 configured for performing techniques in analytics in a utility infrastructure environment. The central office 102 may communicate over a network 104, such as the Internet, with one or more nodes in a network associated with a utility system. The central office 102 may receive data from, and transmit data to, the nodes of the network. In one example, a derivation and/or inference process may be used with the data, to identify one or more analytic events or other desired information. In another example, data received from the utility network may be filtered (e.g., by the use of patterns or templates) to infer or derive at least one measurement, exception or event. The filtration, derivation and/or inference process may be applied to vast quantities of data. The filtered data items may fit, and/or be consistent with, patterns of measurements, exceptions and/or events that indicate an analytic event.

The utility system may include electric, gas, water, sewer, steam or other utility systems. The elements of the system may be configured as a network(s), according to any desired strategy or architecture. FIG. 1 shows examples of both a mesh network 106 and a star network 108, which are but two network architectures according to which the system may be configured.

The mesh network 106 includes a plurality of nodes 110A-110E, which represents any number of nodes. The nodes may be associated with meters, transformers, switches, substations, any supervisory control and data acquisition (SCADA) device, etc., and more generally with any circuit and/or system element with which one- or two-way communication is desired. Within the mesh network 106, the nodes 110 communicate with each other to relay information in a downstream direction 112 and/or an upstream direction 114. Accordingly, the central office 102 may establish and conduct communication with the nodes 110, and may receive data from one or more of the nodes suitable for filtering and processing for analytic events.

Within the star network 108, a central node 116 communicates with one or more downstream nodes, represented by nodes 118A-118D. The star network may include downstream flows 120 of information and/or upstream flows 122 of information. Accordingly, the central office 102 may establish and conduct communication with the nodes 116, 118, and may receive data from one or more of the nodes suitable for filtering and processing for analytic events.

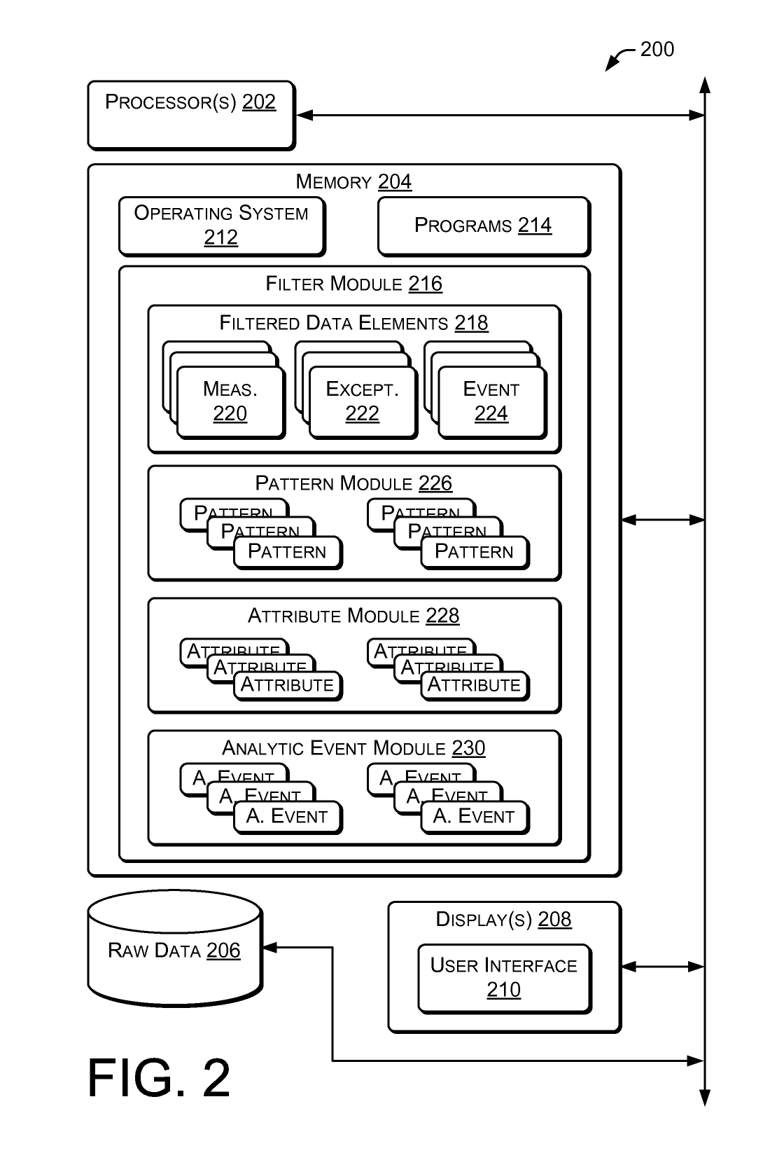

FIG. 2 is a block diagram showing example structure of a system 200 configured for analytics in a utility infrastructure environment. The system 200 is representative of systems that may be operated by the central office 102 (as seen in FIG. 1) or other location, as desired. The system 200 may include one or more processors 202 and memory devices 204. In the example shown, a raw data 206 may be obtained from a plurality of network devices and/or nodes, and may be stored on a high-capacity device. A display 208 may include a view screen or other input/output device which may provide a user interface 210 to an operator or other user.

The memory 204 may include an operating system 212 and one or more programs 214. One or more of the program(s) 214 may be configured for data analysis in a utility environment. The programs may be centrally located at a central office or back office, or may be distributed over a network with portions of code executed at a plurality of locations. Such programs may receive, filter and/or interpret data from the utility network. The data may be filtered, pattern-matched and/or analyzed to derive or infer at least one measurement, exception or event. The filtered data items may be examined for fit and/or consistency with patterns of measurements, exceptions, events and/or attributes that indicate an analytic event. Such analytic events may have value to an operator or the system generally, in that they may indicate issues of utility functionality—such as power quality, theft, device failure, and/or other concerns.

The event derivation module 216 may filter raw data 206 to locate one or more data elements 218 that may be relevant with respect to the identification of one or more analytic events. In the example shown, the event derivation module 216 may filter and/or identify relevant or filtered data elements 218 from among potentially vast quantities of raw data 206. In the example, the filtered data elements 218 may include consumption, voltage, transformer and/or other system measurements 220, data, system and/or network exceptions 222 and events 224. The measurements 220, exceptions 222 and/or events 224 may include electrical, water, gas or other utility measurements. Thus, in the example of FIG. 2, the event derivation module 216 filters the raw data for data elements 218, which may include measured values 220, exceptions 222 and/or events 224.

The event derivation module 216 may compare data elements 218 to one or more patterns within a pattern module 226. Accordingly, the data 218 may be filtered by comparison to known patterns of measurements, exceptions, events and/or attributers that indicate an analytic event. In one example, the patterns module 226 may include one or more patterns associated with one or more analytic events. Thus, one or more patterns may be compared to filtered data elements 218 to identify and/or infer existence of one or more analytic events. The particular data measurements 220, exceptions 222 and/or events 224 identified by any particular filter may be considered to be “building blocks” which indicate and/or infer the existence of a particular analytic event.

In one example of the system 200, the pattern module 226 may be enhanced by the addition of new patterns that identify analytic events. For example, if system operators become aware of an additional analytic event of concern, a pattern of measurements, exceptions and/or events that indicate the analytic event may be defined by a pattern, which may be added to the pattern module 226.

The event derivation module 216 may also consider one or more attributes from an attribute module 228. Attributes may include information that is beyond the scope of the data collected from meters, transformers, switches, substations, valves, etc., of the utility system and/or network. Accordingly, attributes may include information such as demographic information about specific consumers and/or aggregated demographic information about consumers in an area or neighborhood. Attributes may include almost any useful information, such as the nature of the consumer (restaurant, house, etc.), the nature and consumption habits of such consumers, the time of day, the date and the year. Attributes may include information about weather, climate and economy, customer history, prior events at the location, etc. The attributes may also include information obtained from the utility system or network, such as information associated with events. Examples of such attributes include duration of an outage event, magnitude of a voltage spike event, value of a low voltage event or measurement, etc. In a further example of attributes and analytic events, attributes may indicate increased use on one or more transformers and a related (demographic) attribute indicating increased in use of plug-in electric cars. An analytic event may be recognized based on association of these attributes with recognized data elements, defined patterns and/or previously recognized analytic events. In operation, the event derivation module 216 may match and/or consider the filtered data items 218 together with any of a number of attributes 228 in operations that derive, infer and/or detect one or more analytic events. In a specific example, an attribute indicating that a business is closed on the weekends may be considered when determining if low measured consumption data over the weekend is an exception or a normal measured value. In another specific example, a service call attribute may indicate that utility service personnel were on site during the event and therefore the event should be given higher or lower priority, depending on context.

In the process of recognizing analytic events, the event derivation module 216 may also consider one or more previously identified analytic events, which may be recorded in an analytic event module 230. Thus, a “complex” or “compound” analytic event may be inferred (e.g., such as by use of a pattern in the pattern module 226) by utilization of one or more previously recognized analytic events 230, together with one or more filtered data elements 218 and attributes 228. In a specific example, an analytic event (comprising a meter removal/replacement event) may be recognized by power down and power up events. Additionally, the meter removal/replacement analytic event, together with a period of reduced usage by the consumer may indicate a further analytic event (e.g., a meter bypass event). Similarly, a pattern may associate two meter removals with one meter bypass analytic event. And in another example, a meter bypass event may include a pattern of two meter bypass analytic events and a period of reduced usage between them. Accordingly, an analytic event may be used as a building block for a further analytic event. This may be continued in a recursive and/or nested manner for any number of analytic events.

### Example User Interface

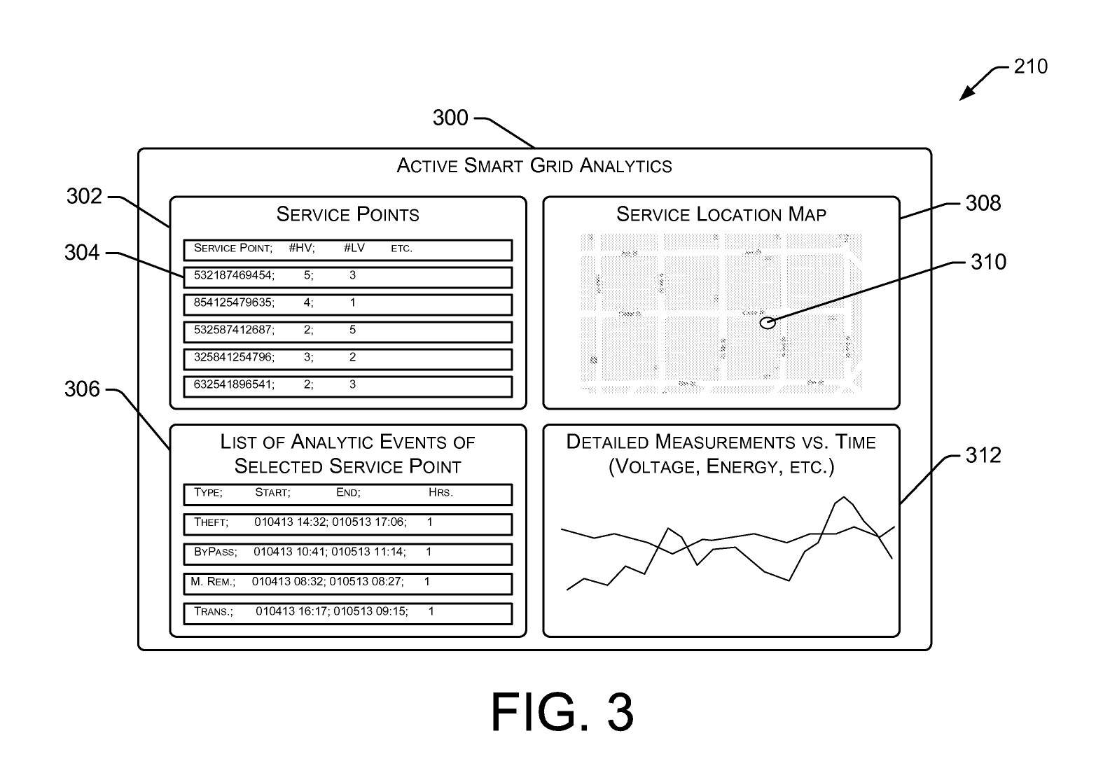

FIG. 3 is an example of a user interface 210 configured as part of an analytics system configured for operation in a utility infrastructure environment. The user interface 210 may be displayed on a screen 300 or other output device, such as at the central office 102 or other location. In the example shown, a listing 302 of one or more service points 304 may be displayed in prioritized order. In one example, the user may select from among a variety of prioritized orders, such as longest outage, worst low voltage event, etc. Each service point 304 may be identified by customer number or other identification.

The user interface 210 may include a listing of analytic events 306 that the system (e.g., system 200 of FIG. 2) has identified with respect to a selected service point 304. The listing of analytic events 306 may be prioritized, such as with the most serious, costly and/or important event listed first. The listing of analytic events 306 may be linked to the listing of service points, in that the analytic events 306 displayed occurred at the selected service point 304. In the example user interface 210, the analytic events shown in 306 occurred at the selected service point 304, indicating a variety of events consistent with potential energy theft activity. Selecting the prioritized service point 304 allows the operator to investigate all analytic events occurring at that service point in a relevant time frame.

The user interface 210 may include a map 308 of the location 310 of the selected service point. The user interface 210 may also include a graphic 312 of measured energy (e.g., current use) and voltage at the service location 304.

In operation, a system operator may view the prioritized listing 306 of analytic events, which is associated with the list of service points 302. The operator may send resources (e.g., service trucks and workers) to address the most significant analytic events. Significantly, the analytic events 306 are presented to the operator. That is, the operator does not have to consider lower-level data (e.g., measured values, exceptions, events, attributes and/or previously identified analytic events), and does not have to derive current analytic events from such information.

### Example Methods

In some examples of the techniques discusses herein, the methods of operation may be performed by software defined on memory and/or application specific integrated circuits (ASIC). The memory 204, 206 may comprise computer-readable media and may take the form of volatile memory, such as random access memory (RAM) and/or non-volatile memory, such as read only memory (ROM) or flash RAM. Computer-readable media includes volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include communication media, such as modulated data signals and carrier waves.

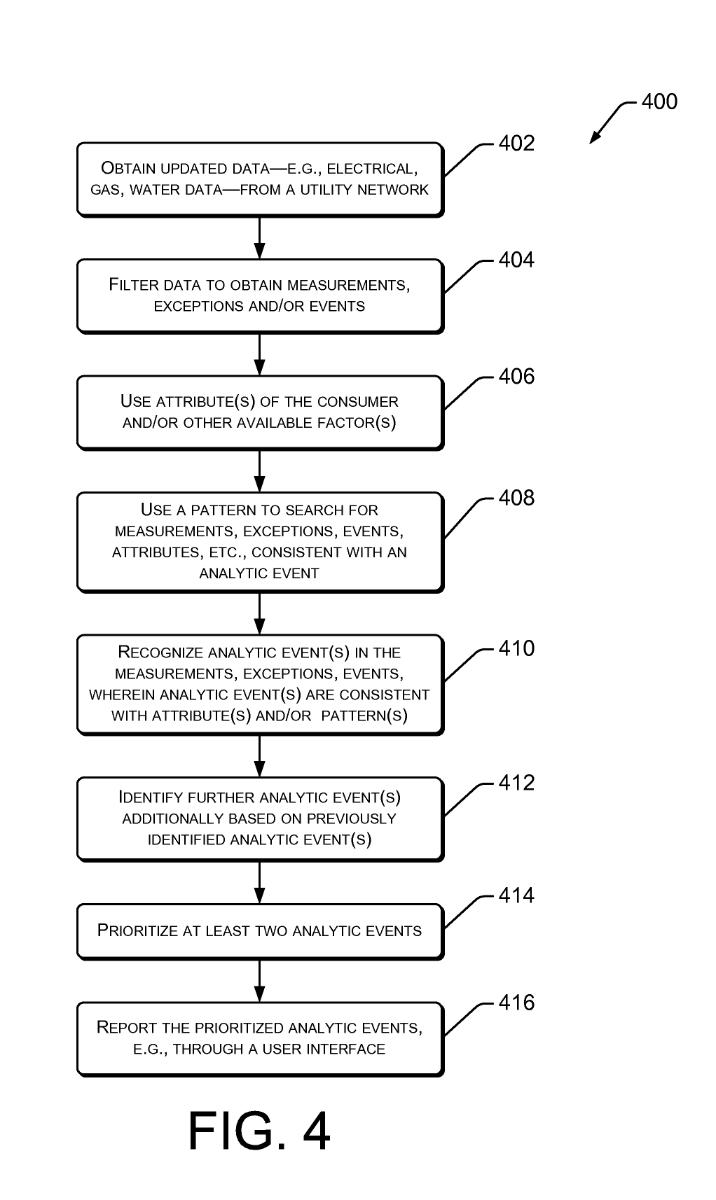

FIG. 4 is a flow diagram showing an example method 400 to identify analytic events in a utility infrastructure environment. In one example, data may be filtered to obtain measurements, exceptions and events. Attributes and patterns may be used to identify one or more analytic events. Once identified, analytic events may be may be prioritized and reported to an operator or utility system through operation of a user interface, automated notification system, or automated utility system that may take action without human intervention. Examples of analytic events include utility theft and/or system diagnostics, problems and failures.

At operation 402, updated data is obtained from a utility network. The data may be related to the operation or state of any utility system. Examples of such systems include an electrical grid, or a water, steam, natural gas, sewer or other utility system. In the context of the example of FIG. 1, the mesh network 106 or the star network 108 are able to conduct data to the central office 102, where the system 200 of FIG. 2 may be in operation. The data may be refreshed, recorded and/or reported from each node at periodic intervals (e.g., 5 minutes, 15 minutes, 60 minutes or 24 hours, etc.). The nodes may include meters, transformers, switches, substations, etc., and more generally with any circuit and/or system element with which one- or two-way communication is desired.

At operation 404, the data are filtered. In the context of the example of FIG. 2, the filtering may identify one or more measurements (e.g., electric consumption measurements), exceptions (e.g., possibly erroneous consumption measurements), and events (e.g., service power-down). Within this data may be one or more “building blocks” of one or more analytic events.

At operation 406, attributes of consumer(s) and/or other available information are considered along with the filtered data, to determine if a pattern is established and a particular analytic event is indicated. In the context of the example of FIG. 2, a number of attributes may be associated with portions of the data. For example, demographic information may be associated with an individual consumer or consumers within a region. Weather information may be associated with consumers in a region for some utilities (e.g., electricity or gas) but not for others (e.g., sewer or garbage). In some examples, the use of attributes may assist help to distinguish measurement data from exception data. For example, electrical consumption may be very high for a particular consumer. However, an attribute may indicate that the weather is very cold. Accordingly, the high electrical consumption may not be considered to be an exception. Similarly, demographic information may used to assist in identifying exceptions. Increased population density and/or a rising economy may indicate that increased utility consumption does not constitute an exception.

At operation 408, measurements, exceptions, events, attributes, etc., may be searched for consistency with an analytic event. In the example of FIG. 2, the event derivation module 216 may utilize a number of patterns or filters (e.g., patterns from the pattern module 226) or otherwise derive or infer an analytic event. Each pattern may match measurements, exceptions and/or events consistent with a particular analytic event. Accordingly, by comparing the data to a plurality of patterns, a check may be made for consistency with a plurality of analytic events, respectively. In particular, if the filtered data match a particular pattern, then a particular analytic event may be indicated.

At operation 410, analytic event(s) are recognized in the measurements, exceptions and events. In one example, the analytic event(s) are also consistent with one or more attribute(s) and/or pattern(s). Thus, one or more particular or specific analytic events may be identified.

At operation 412, further or additional analytic events may be identified based in part on a pattern of meter measurements, meter exceptions, events, attributes and/or previously identified analytic event(s). In the context of the example of FIG. 2, one or more previously discovered analytic events may be indicated by the analytic events module 230. These analytic events may be considered along with measured data 220, exceptions 222, events 224 and/or attributes 228 to determine if additional analytic events have occurred. In particular, one or more of the patterns 226 may include analytic events indicated by module 230.

At operation 414, the analytic events that have been identified may be prioritized into a list or other hierarchy. The prioritization may be made according to a monetary value of each analytic event or based on a value of a perceived threat to the operation of the system (e.g., electrical grid).

At operation 416, the prioritized list of analytic events may be reported to an operator. In the context of the examples of FIGS. 2 and 3, the user interface 210 may be used to report the prioritized list of analytic events to the operator. Additionally and/or alternatively, the system (e.g., system 200 of FIG. 2) may initiate an automated response, including texts, emails, messages, and/or direct intervention, changes or input to the system or grid in response to one or more analytic events.

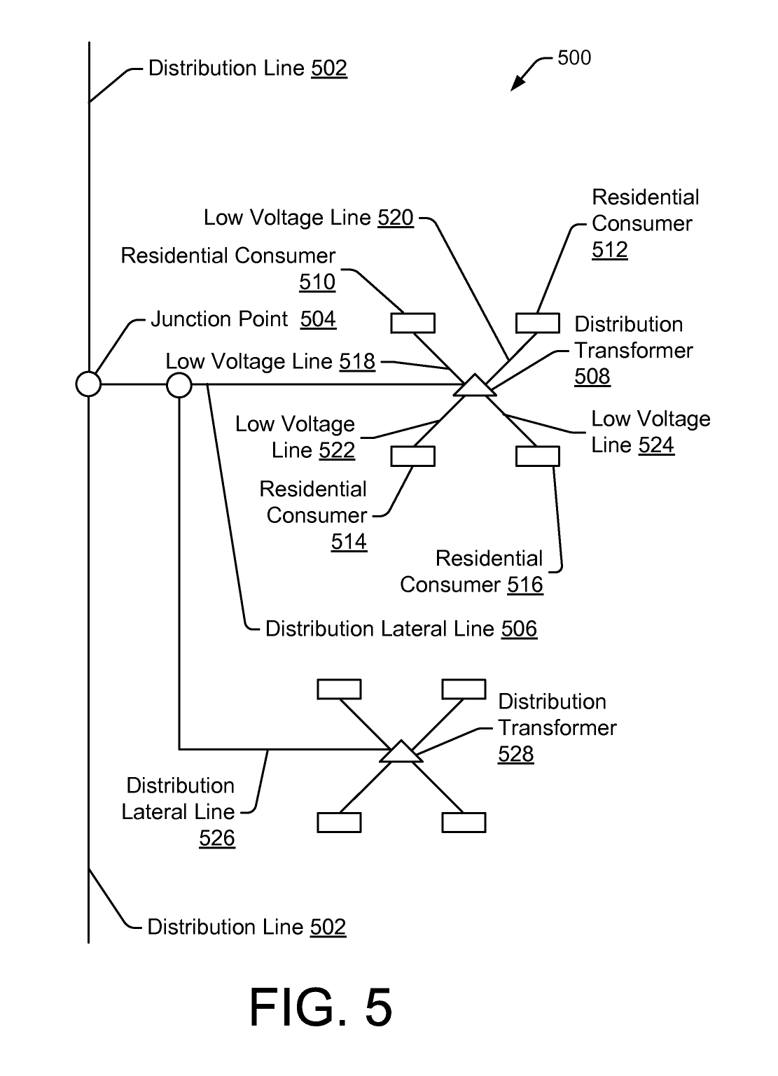

FIG. 5 provides a specific example of the use of one analytic event in the identification of another analytic event, such as discussed at operation 410 in FIG. 4. FIG. 5 shows a portion of an electrical grid 500 illustrating a distribution line 502 that provides energy through a junction point 504 to a distribution lateral line 506. The distribution lateral line 506 provides power through transformer 508 to four houses 510-516 through low voltage power lines 518-524. In one example, data indicating a power outage event at houses 510-516 may be received by system 200 (of FIG. 2). Based on data events indicating failure of four houses, the system 200 may infer a single analytic event indicating a failure of the transformer 508 rather than four separate analytic events occurring at houses 510-516. In particular, a pattern within the pattern module 226 may indicate that power outage events at all sites associated with a single transformer may indicate an analytic event of a transformer failure.

Additionally, a second lateral distribution line 526 and transformer 528 may provide service to additional houses. If similar circumstances result in an analytic event indicating failure of transformer 528 then the two analytic events may be considered by the system 200. A pattern in the pattern module 226 may indicate that analytic events indicating the failure of two transformers 508, 528 should result in a single, higher level analytic event indicating possible de-energization of distribution lateral line 506 at junction 504. One or more attributes and/or a connectivity model provide the system with information on which devices are connected and the nature of that connection. In one example, the event derivation module 218 is configured to identify a low voltage event in part by using connectivity attributes or a network topology. Thus, measurements, exceptions, events, attributes and analytic events may all be considered in determining if potentially unrelated groups of events are actually part of a single, larger event. This eliminates the need to investigate each underlying event individually, allowing resources to focus on a single cause, a failure at a single junction point in this example.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

What is claimed is:

1. One or more computer-readable media storing computer-executable instructions that, when executed, cause one or more processors to perform acts comprising:
filtering data obtained from a utility network to derive exceptions and events, wherein the deriving is based in part on:
use of at least one attribute, wherein the at least one attribute is associated with a consumer; and
use of at least one pattern, wherein the at least one pattern is related to at least one analytic event, respectively;
recognizing at least one analytic event in the identified exceptions and events, wherein the recognized analytic event is consistent with the at least one attribute and consistent with the at least one pattern; and
reporting the at least one analytic event.

2. One or more computer-readable media as recited in claim 1, wherein use of the at least one attribute assists in distinguishing measurement data from exceptions.

3. One or more computer-readable media as recited in claim 1, wherein:
use of the at least one attribute comprises use of demographic information that assists in identifying exceptions.

4. One or more computer-readable media as recited in claim 1, wherein:
use of the at least one attribute comprises use of weather information.

5. One or more computer-readable media as recited in claim 1, additionally comprising:
prioritizing at least two analytic events;
wherein the reporting comprises reporting the at least two analytic events according to the prioritization.

6. One or more computer-readable media as recited in claim 1, additionally comprising:
recognizing nested analytic events.

7. One or more computer-readable media as recited in claim 1, wherein the at least one pattern includes at least a previously recognized analytic event.

8. One or more computer-readable media as recited in claim 1, wherein recognizing the at least one analytic event comprises recognizing a conservation analytic event.

9. One or more computer-readable media as recited in claim 1, wherein recognizing the at least one analytic event is based in apart on:
an attributed used to recognize increased use on one or more transformers; and
an attribute used to recognize demographics indicating an increase in use of plug-in electric cars.

10. One or more computer-readable media as recited in claim 1, wherein:
filtering data comprises deriving electric measurements;
filtering data comprises deriving water measurements; or
filtering data comprises deriving gas measurements.

11. One or more computer-readable media as recited in claim 1, additionally comprising:
obtaining data from the utility network, wherein the data comprises electrical consumption data, switch settings and/or transformer data.

12. A system for analyzing data, comprising:
a processor and a memory;
an event derivation module, defined in the memory and executed by the processor, to:
filter the data for at least one measurement, at least one exception and at least one event; and
identify at least one analytic event in the filtered data;
a pattern module comprising at least one pattern, wherein the at least one analytic event is identified by the event derivation module using the at least one pattern; and
a user interface to report the at least one analytic event.

13. The system of claim 12, wherein the filter event derivation module is configured to identify the at least one analytic event based at least in part on at least one attribute.

14. The system of claim 12, wherein the event derivation module is configured to identify the at least one analytic event based at least in part on a demographics attribute and a weather attribute.

15. The system of claim 12, wherein the event derivation module is configured to identify a further analytic event based in part on the at least one analytic event.

16. The system of claim 12, wherein the event derivation module is configured to utilize connectivity attributes or a network topology to derive an analytic event.

17. The system of claim 12, wherein the event derivation module is configured to identify an outage event in part by using connectivity attributes or a network topology.

18. A method of presenting a user interface, comprising:
under control of one or more processors configured with executable instructions:
displaying service points prioritized according to importance of associated analytic events; and
displaying analytic events of a selected service point.

19. The method of claim 18, wherein content within the display of selected analytic events is obtained by acts comprising:
filtering data obtained from a utility network to derive exceptions and events, wherein the deriving is based in part on:
use of at least one attribute, wherein the at least one attribute is associated with a consumer; and
use of at least one pattern, wherein the at least one pattern is related to at least one analytic event, respectively;
recognizing at least one analytic event in the identified exceptions and events, wherein the recognized analytic event is consistent with the at least one attribute and consistent with the at least one pattern.

20. The method of claim 18, additionally comprising:
displaying a location of a selected one of the displayed service points on a map; and
displaying interval data, including recent voltage levels and current consumption levels, of the selected one of the displayed service points.
